(19) United States
(12) Patent Application Publication
(10) Pub. No.: US 2003/0048389 A1
(43) Pub. Date: Mar. 13, 2003

(54) Multiple bit stream directional video monitor apparatus and process

(76) Inventor: Ray M. Alden, Raleigh, NC (US)

Correspondence Address: Ray M. Alden, 808 Lake Brandon Trail, Raleigh, NC, 27610, US

(21) Appl. No.: 09/950,300

(22) Filed: Sep. 10, 2001

(51) Int. Cl. H04N 9/12; H04N 5/66

(52) U.S. Cl. 348/739; 348/832

(57) ABSTRACT

The present invention uses concentrated pixels to enable pixels from three video streams to side by side concurrently occupy the space that would normally be taken by one video pixel. In operation, visible light from each of the three concentrated pixels is then directed by an optic into a respective segment of the user space. A monitor comprised of arrays of said concentrated pixels each emitting visible light which is directed by optics into three distinctive users spaces. Users within each respective user space see unique video steams across the entire surface of the video monitor which are not visible to those in other respective user spaces. Using the techniques described, two or more video streams can be displayed concurrently on one video monitor concurrently. Examples of CRT, projection, and LCD embodiments are described.

### BACKGROUND FIELD OF INVENTION

Modem video monitors incorporate many technologies and methods for providing high quality video to users. Nearly every household in the United States has one or more video monitors in the form of a television or a computer monitor. These devices generally use technologies such as Cathode Ray Tubes (CRT) tubes, Liquid Crystal Displays (LCD), or Digital Micromirror Devices (DMD) projection in one way or another. Large monitors offer the advantage of enabling many users to see the video monitor simultaneously as in a living room television for example. Often video users do not want to view the same video streams as one another.

The prior art describes some attempts to enable multiple viewers to see different video streams concurrently on the same monitor. These are generally drawn to wearing glasses that use polarization or light shutters to filter out the unwanted video stream while enabling the desired video stream to pass to the users' eyes. No prior art provides a technique to enable multiple viewers to view separate video streams concurrently with the unaided eye.

The present invention provides a significant step forward for video monitors. The present invention describes multiple embodiments which enable multiple video streams to be displayed on the same video monitor concurrently. Each embodiment describes the concurrent presentation and separation of three video streams by providing a three fold increase in pixels, said pixels including side by side concurrent pixel segments from the three video streams wherein post pixel optics cause the three respective video streams to be visible in a physically segmented user space. The result is that three groups of users can sit in three viewing zones wherein people in each of the zones can view different video streams on the same monitor concurrently.

### BACKGROUND-DESCRIPTION OF PRIOR INVENTION

Many display screens have been described and practiced in the prior art. Modern video monitors incorporate many technologies and methods for providing high quality video to users. Nearly every household in the United States has one or more video monitors in the form of a television or a computer. These devices generally use technologies such as Cathode Ray Tulbes (CRT) tubes, Liquid Crystal Displays (LCD), or Digital Micromirror Devices (DMD) in one way or another. Large monitors offer the advantage of enabling many users to see the video monitor simultaneously as in a living room for example. Often video users do not want to view the same video streams as one another.

The prior art describes some attempts to enable multiple viewers to see different video streams concurrently on the same monitor. These are generally drawn to wearing glasses that use polarization or light shutters to filter out the unwanted video stream while enabling the desired video stream to pass to the users' eyes. U.S. Pat. No. 6,188,442 Narayanaswami being one such patent wherein the users where special glasses to see their respective video streams. U.S. Pat. No. 2,832,821 DuMont does provide a device that enables two viewers to see multiple polarized images from the same polarizing optic concurrently. DuMont however also requires that the viewers use separate polarizing screens as portable viewing aids similar to the glasses. DuMont further requires the expense of using two monitors concurrently. No prior art provides a technique to enable multiple viewers to view separate video streams on the same monitor concurrently with the unaided eye as does the present invention.

### BRIEF SUMMARY

The invention described herein represents a significant improvement for the users of video monitors. Heretofore a large family size television for example could only carry one video stream on its entire surface at any given time. Anyone not interested in watching the same video stream was required to use a television in another room or in the case of “picture in picture” to view the video stream on a smaller portion of the same monitor. Likewise if a family member wanted to use the computer or video game, they would have to go to a separate computer or gaming station with a monitor. The present invention enables multiple users to use one video monitor concurrently while each views completely different video content concurrently whether television video, computer video, gaming video, or some other form of video.

The present invention uses concentrated pixels to enable pixels from three video streams to side by side concurrently occupy the space that would normally be taken by one video pixel. In operation, visible light from each of the three concentrated pixels is then directed by an optic into a respective segment of the user space. A monitor comprised of arrays of said concentrated pixels each emitting visible light which is directed by optics into three distinctive users spaces. Users within each respective user space see unique video steams across the entire surface of the video monitor which are not visible to those in other respective user spaces. Using the techniques described, two or more video streams can be displayed concurrently on one video monitor concurrently. Examples of CRT, projection, and LCD embodiments are described.

Thus the present invention offers a significant advancement in the functionality of video monitors.

### OBJECTS AND ADVANTAGES

Accordingly, several objects and advantages of my invention are apparent. It is an object of the present invention to provide a monitor which enables multiple viewers to experience completely different video streams simultaneously. This enables families to spend more time together while simultaneously independently experiencing different visual media or working on different projects in the presence of one another. Energy can be saved by concentrating visible light energy into narrower user space when just one person is using a monitory. Likewise when multiple users use the same monitor instead of going into a different room, less electric lighting is required. Also, by enabling one monitor to operate as multiple monitors, living space can be conserved which would otherwise be cluttered with a multitude of monitors.

It is an advantage that the present invention doesn't require special eyewear, eyeglasses, goggles, or portable viewing devices as does the prior art.

Further objects and advantages will become apparent from the enclosed figures and specifications.

### DRAWING FIGURES

FIG. 1 illustrates select modified CRT elements of a segmented three stream pixel of the present invention.

FIG. 2 prior art, illustrates the viewing angle of a PACRT (prior art CRT) single stream pixel.

FIG. 3a is the RV (right view) user space angle of a modified segmented pixel of the present invention.

FIG. 3b is the CV (center view) user space angle of a modified segmented pixel of the present invention.

FIG. 3c is the LV (left view) user space angle of a modified segmented pixel of the present invention.

FIG. 4 illustrates the modified CRT elements of the present invention.

FIG. 5a illustrates the RV (right view) user space of a modified CRT monitor of the present invention.

FIG. 5b illustrates the CV (center view) user space of a modified CRT monitor of the present invention.

FIG. 5c illustrates the LV (left view) user space of a modified CRT monitor of the present invention.

FIG. 6 illustrates the concurrent RV, CV, and LV in the user space of a CRT monitor of the present invention.

FIG. 7 is a flowchart of some element of the multi-Bit stream CRT of the present invention.

FIG. 8 prior art shows elements of prior art projection TV elements including the PAP (prior art projection) viewing angle.

FIG. 9 is an enlarged view of one pixel of FIG. 8 with the PAP viewing angle.

FIG. 10 illustrates the three modified segmented viewing angles of the present invention in the projection TV embodiment.

FIG. 11 is one enlarged segmented three stream pixel of FIG. 10.

FIG. 12 prior art illustrates four mirror elements of a DMD.

FIG. 13 shows the segmented DMD video elements of the present invention.

FIG. 14 is a flow chart of the multi bit stream DMD process of the present invention in the projection TV embodiment.

FIG. 15 prior art is a LCD pixel with the PALC (prior art liquid crystal) viewing angle.

FIG. 16 is a segmented pixel LCD with multiple viewing angles A, B, and C of the present.

FIG. 17 is a flowchart of the multi-bit stream LCD process of the present invention.

### DETAILED DESCRIPTION OF THE INVENTION

First Embodiment

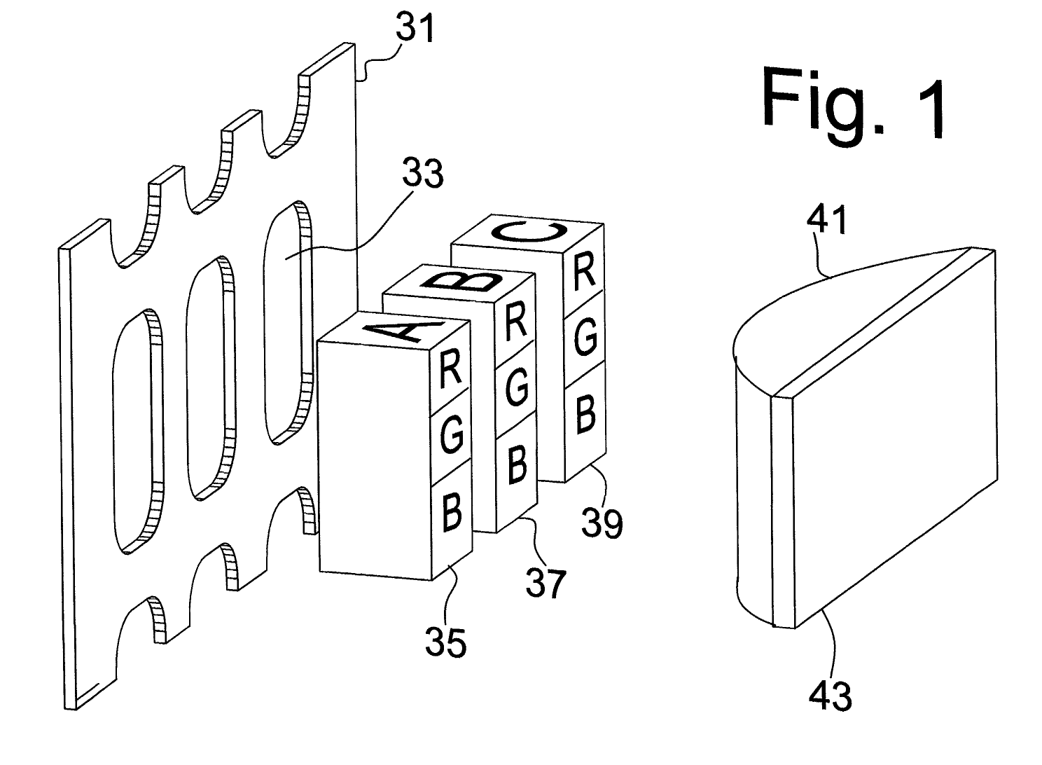

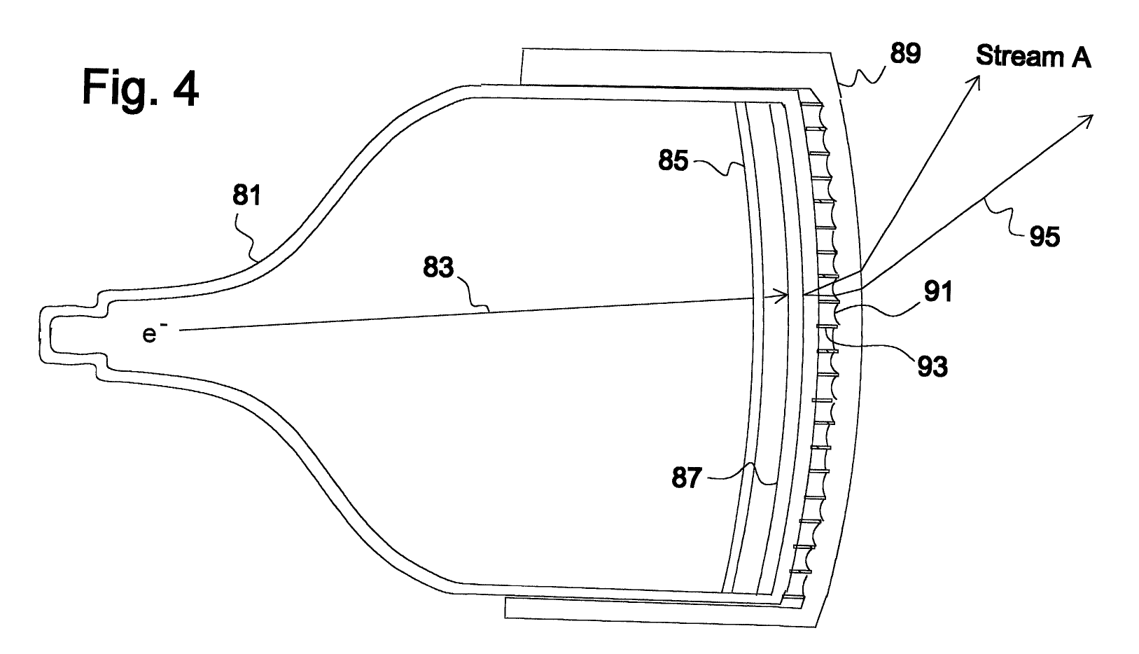

FIG. 1 illustrates select modified CRT elements of a segmented three stream pixel of the present invention. A shadow mask 31 has a series of holes similar to a hole 33. On one side of the 31 is a layer of phosphors such as an A phosphor set 35, a B phosphor set 37, and a C phosphor set 39. These phosphors are deposited onto the surface of a CRT tube (not shown) by processes well known in the prior art they need not be separated as illustrated. Beyond the phosphors (and the CRT glass not shown) is CRT segmented pixel lens 41 which has a columnar lens on a first surface and a planar lens on a second surface referred to as a planar CRT surface 43). The 43 is the exposed monitor surface which the user sees. The 41 and 43 reside in a structure similar to 89 of FIG. 4.

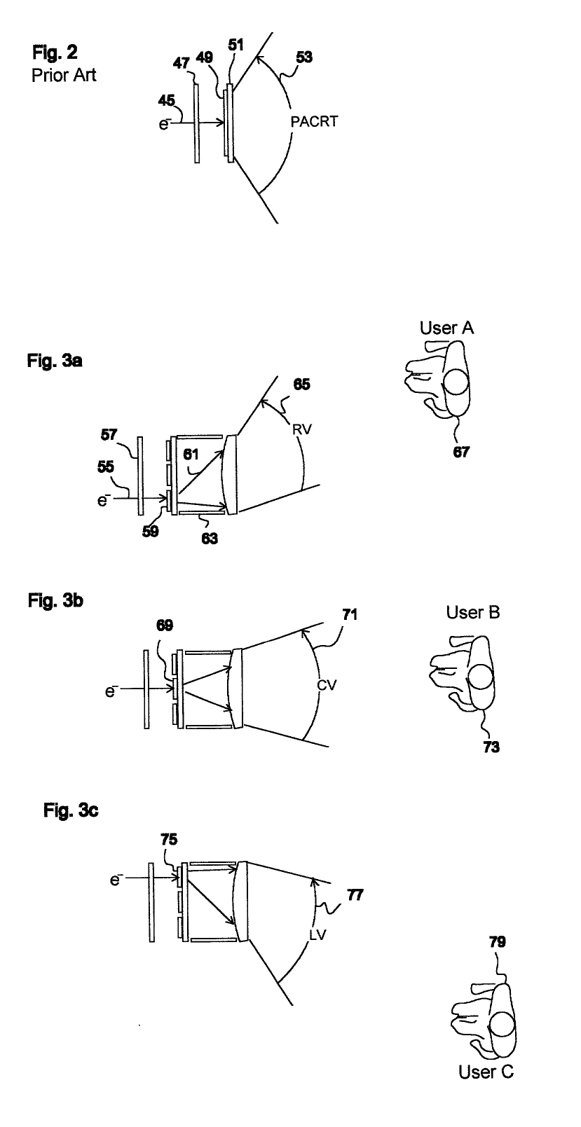

FIG. 2 prior art, illustrates the viewing angle of a PACRT (prior art CRT) single stream pixel. A prior art electron stream 45 is fired through a prior art shadow mask 47 to strike a prior art phosphor pixel 49 which is deposited on a prior art CRT glass 51. Said phosphor pixel then illuminates the user space such that a user within a PACRT user space can see the pixel.

FIG. 3a is the RV (right view) user space angle of a modified segmented CRT pixel of the present invention. An electron stream 55 passes through a segmented shadow mask 57 striking a first phosphor section 59 which emits a segmented visible light 61 and 63 said light then passing through a CRT pixel segmenting lens 64 to produce a first viewing angle range 65 in a user space. A user A 67 being within said first viewing angle. The 64 resides in a structure similar to 89 of FIG. 4.

FIG. 3b is the CV (center view) user space angle of a modified segmented CRT pixel of the present invention. 3b is the same pixel as 3a with the electron stream having advanced to the next segment of the pixel. A center CRT pixel segment 69 emits visible light which is viewable in a center CRT viewing angle 71. User B 73 being within said viewing angle.

FIG. 3c is the LV (left view) user space angle of a modified segmented CRT pixel of the present invention. 3c is the same pixel as 3a with the electron stream having advanced two pixel segments. A right CRT pixel segment 75 emits visible light which is viewable in a left CRT viewing angle 77. User C 79 being within said viewing angle.

FIG. 4 illustrates the modified CRT elements of the present invention. A CRT 81 has within it the element to fire electrons 83 through a modified shadow mask 85 such that they strike the present invention phosphors 87. 87 then emitting angularly directed light 95. Said light being so directed by a pixel lens array containing elements similar to arrayed pixel lens 91. Said pixel lenses are separated from on another using light absorbing barriers similar to barrier 93 which are integrated into a CRT lens array assembly 89 consisting of the lens array and barriers that are used to segment the phosphor light into distinct viewing angles using the 91 and similar structures for each segmented pixel elements while preventing cross contamination using the 93 and similar structures for each segmented pixel element. The 91 operating as a lens and the 93 operating as a light absorbing barrier.

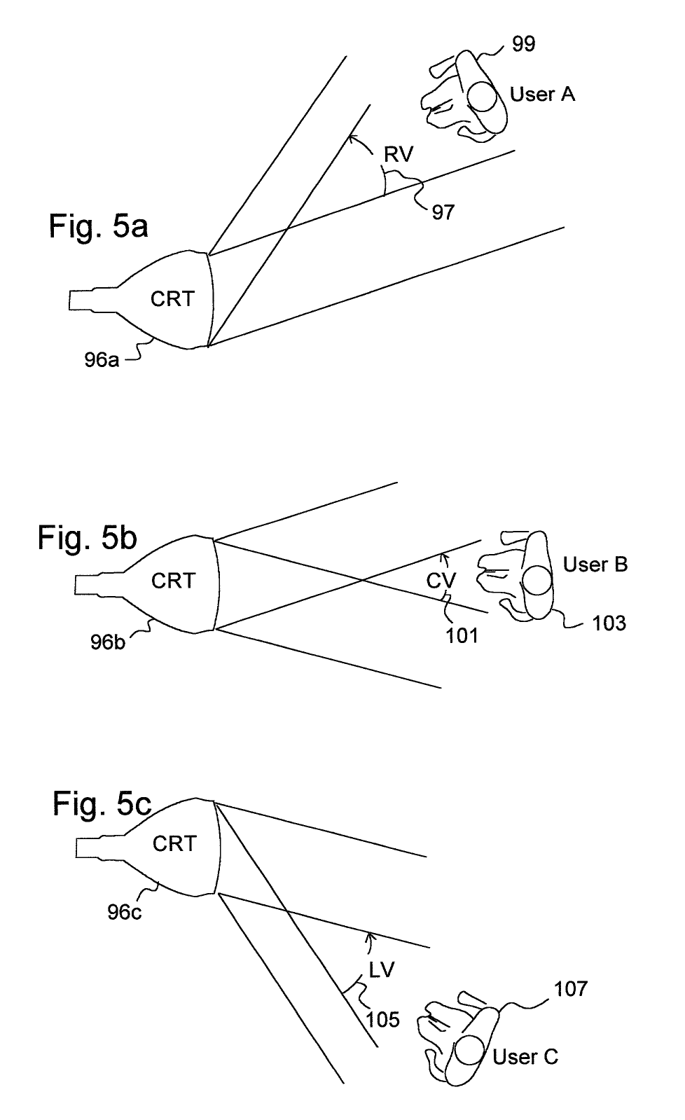

FIG. 5a illustrates the RV (right view) user space of a modified CRT monitor of the present invention. A functioning CRT 96a includes the elements described in FIG. 4 and of FIG. 3a. When all of the left hand pixel elements (similar to 59) are excited by electrons, they emit a video stream which is fully viewable only in the RV viewer space 97. A viewer A 99 seeing the video stream on the entire front (right side) surface of the 96a.

FIG. 5b illustrates the CV (center view) user space of a modified CRT monitor of the present invention. A functioning CRT 96b is the same CRT as 96a, it includes the elements described in FIG. 4 and of FIG. 3a. When all of the center pixel elements (similar to 69) are excited by electrons, they emit a video stream which is fully viewable only in the CV viewer space 101. A viewer B 103 seeing the video stream on the entire front surface of the 96b.

FIG. 5c illustrates the LV (left view) user space of a modified CRT monitor of the present invention. A functioning CRT 96c is the same CRT as 96a, it includes the elements described in FIG. 4 and of FIG. 3a. When all of the right hand pixel elements (similar to 75) are excited by electrons, they emit a video stream which is fully viewable only in the LV viewer space 105. A viewer C 107 seeing the video stream on the entire front surface of the 96c.

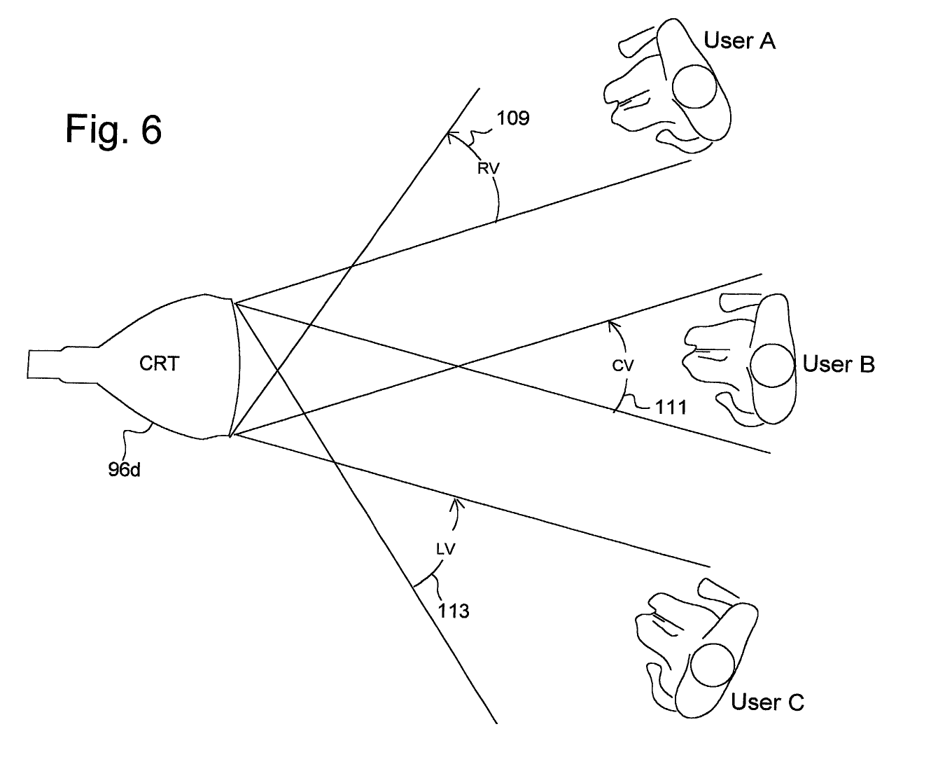

FIG. 6 illustrates the concurrent RV, CV, and LV in the user space of a CRT monitor of the present invention. It includes the same CRT 96d as was in FIGS. 5a, 5b, and 5c except the three video streams and users are displayed concurrently. A first user space 109, a second user space 111, and a third user space 113 each respective receive completely different video streams concurrently.

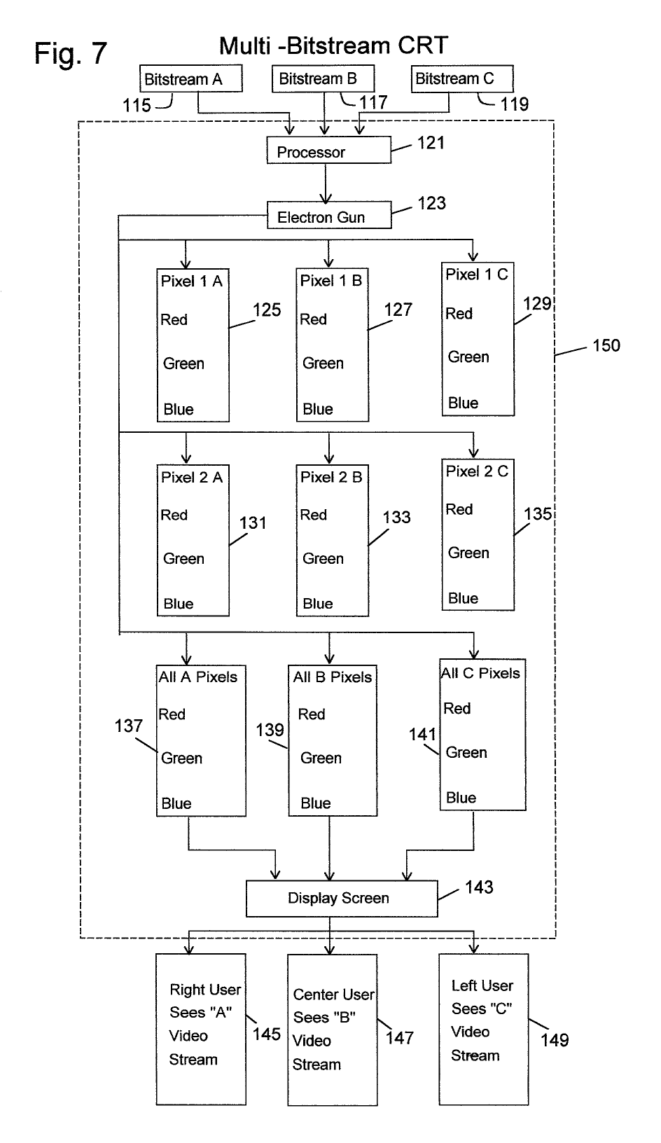

FIG. 7 is a flowchart of some element of the multi-Bit stream CRT of the present invention. A CRT bit stream A 115, a CRT bit stream B 117, and a CRT bit stream C 119 all pass through a CRT processor 121. A CRT electron gun 123 excites phosphors in series such that a first 1A pixel segment 125 is excited to convey information from the 115 bit stream, then a second 1B pixel segment is excited to convey information from the 117, and a third 1C pixel segment is excited to convey information from the 119. The electron gun the proceeds to excite all of the pixel segments on the entire monitor according to the process of exciting a segment with the 115 information, then a segment with the 117 information, then a segment 119 information. Visible light from said excited pixels being displayed on a CRT display screen 143. Whereupon a right hand CRT user sees bit stream A 145, a center CRT user sees bit stream B 147, and a left hand CRT user sees bit stream C 149.

Second Embodiment

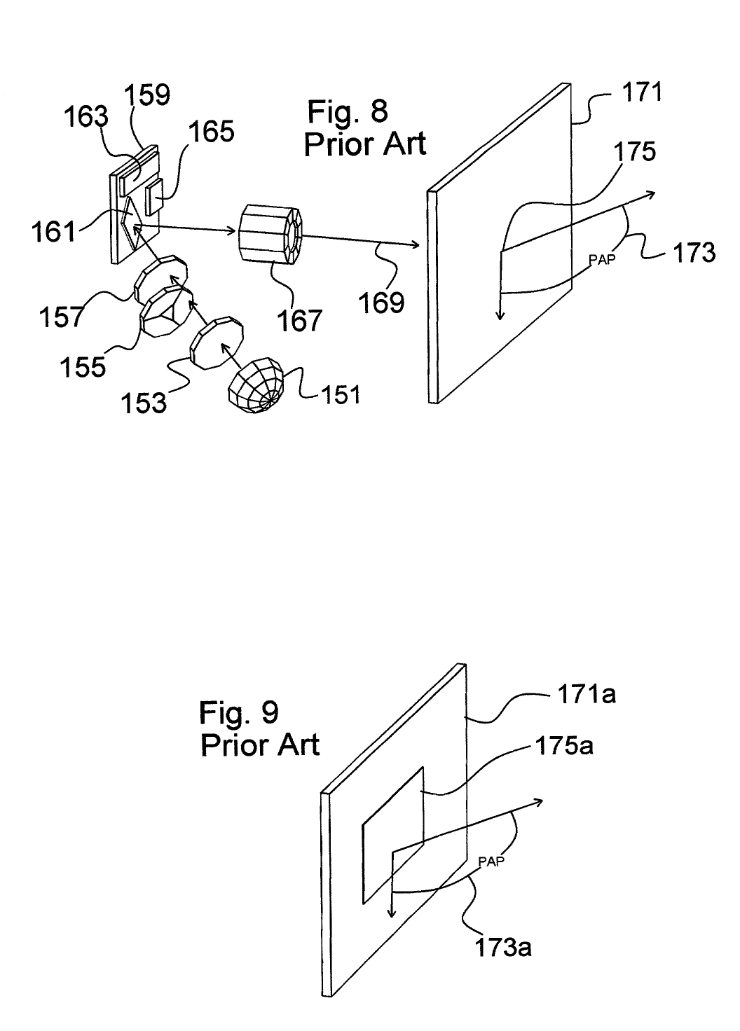

FIG. 8 prior art shows elements of prior art projection TV elements including the PAP (prior art projection) viewing angle. A prior art light 151 passes through a first prior art optic 153, through a prior art color filter 155, a second period art optic 157, reflecting off a prior art DMD 161, through a prior art lens 167, to emerge as a series of prior art color pixels 169. Each pixel such as prior art projection pixel 175 being observable on a prior art projection screen 171 across an angle in prior art user space 173.

FIG. 9 is an enlarged view of one pixel of FIG. 8 with the PAP viewing angle. An enlarged prior art projection screen 171a having one such enlarged prior art projection pixel 175a which is viewable across a prior art projection pixel viewing angle 173a.

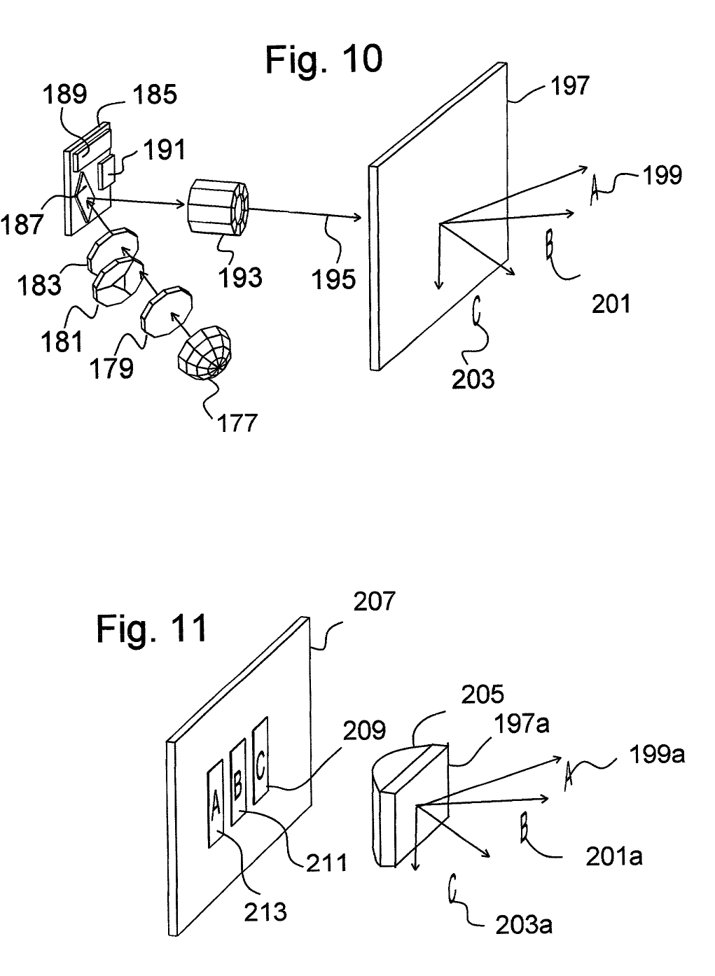

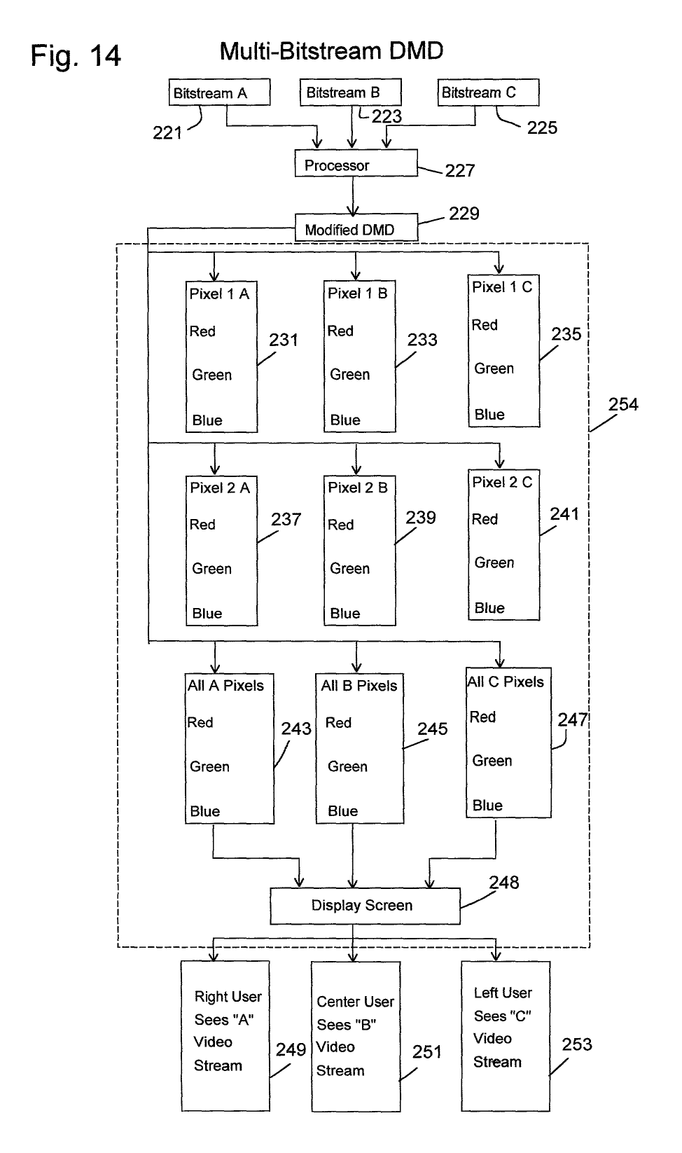

FIG. 10 illustrates the three modified segmented viewing angles of the present invention in the projection TV embodiment. A light 177 passes through a first optic 179, through a color filter 181, a second optic 183, off a modified DMD 187, through a lens 193, to emerge as a series of color pixels 195. Each pixel being segmented and the visible light of which is directed into three distinct streams from a modified projection screen 197. A projection stream 199 being observable within a first projection user space, B stream 201 being observable in a second projection user space, and C stream 203 being observable in a third projection user space. Said segments being so directed according to the art of FIG. 11 into three sections. Said modified DMD being modified according to the art of FIG. 13. A DMD processor 189, and a memory 185 being integrated into a modified DMD chip 185.

FIG. 11 is one enlarged segmented three stream pixel of FIG. 10. It is an enlarge view of one projection screen 207 pixel segmented into three information streams. A projection stream 213 is displayed on the screen, as is B projection stream 211, and C projection stream 209. Light of each respective stream is directed by a cylindrical planar projection lens with a cylindrical side 205 and a planar side 197a. Such that the video information is segmented into three distinct user spaces. Projection user space A 199a receiving the A stream, projection user space B 201a receiving the B stream, and projection user space C 203a receiving the C projection stream. The 197a being a blown up small section of the 197 surface. The 207 being similar in function and structure to 171 a prior art element. The 205 being similar in structure and performance to the 91 element of FIG. 4. The 205 and the 197a being elements representing one segmented pixel component performing similarly and structured similar to element 89 of FIG. 4, incorporating elements similar to 91 and 93 also of FIG. 4.

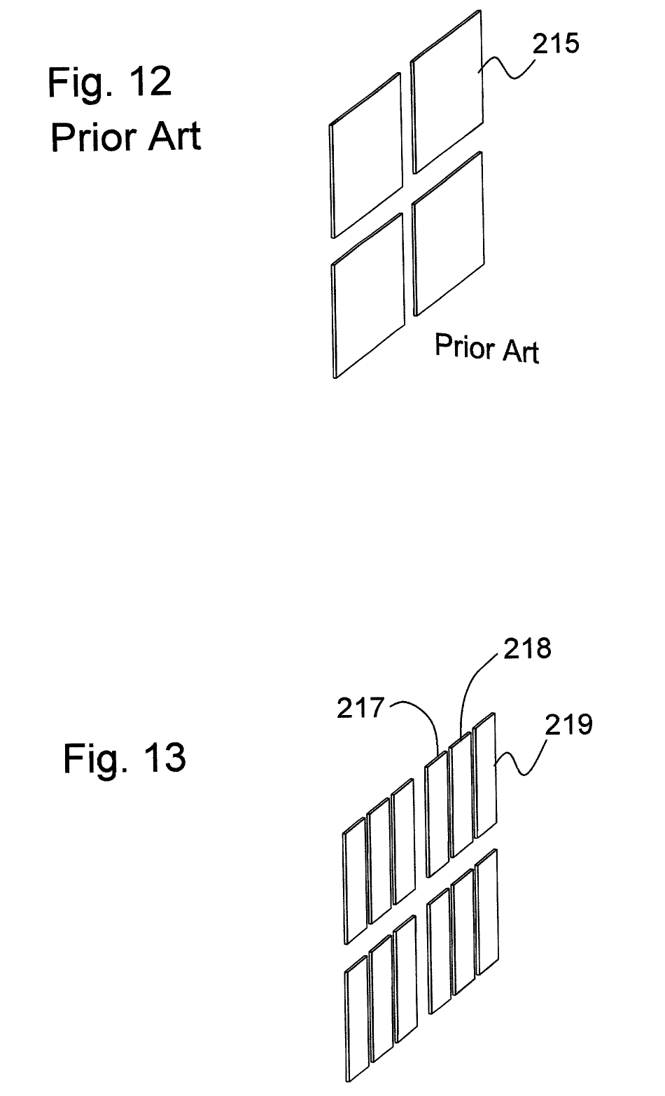

FIG. 12 prior art illustrates four mirror elements of a DMD. Each prior art mirror segment similar to prior art segment 215 is designed to carry information from one pixel into the projected user space. FIG. 12 is an enlarged view of a small section of 161 of FIG. 8.

FIG. 13 shows the segmented DMD video elements of the present invention. FIG. 13 illustrates that the 215 section of FIG. 12 is replaced by a first mirror segment 217, second mirror segment 218, and third mirror element 219. The 217 carries the A projection stream, the 218 carries the B projection stream and the 219 carries the C projection stream of FIG. 11. FIG. 13 is an enlarged view of a small section of 187 of FIG. 10.

FIG. 14 is a flow chart of the multi bit stream DMD process of the present invention in the projection TV embodiment. A DMD bit stream A 221, a DMD bit stream B 223, and a DMD bit stream C 225 all pass through a DMD processor 227. A modified DMD 229 reflects light such that A first 1A pixel segment 231 is reflected to convey information from the 221 bit stream, a second 1B pixel segment is reflected to convey information from the 223, and a third 1C pixel segment is reflected to convey information from the 225. The modified DMD also reflects all of the pixel segments on the three entire video streams according to the process of reflecting a segment with the 221 information, a segment with the 223 information, and a segment 225 information. Visible light from said reflected pixels being displayed on a DMD display screen 248 which has an element similar to 89 of FIG. 4. Whereupon a right hand DMD user sees bit stream A 249, a center DMD user sees bit stream B 251, and a left hand DMD user sees bit stream C 253.

Third Embodiment

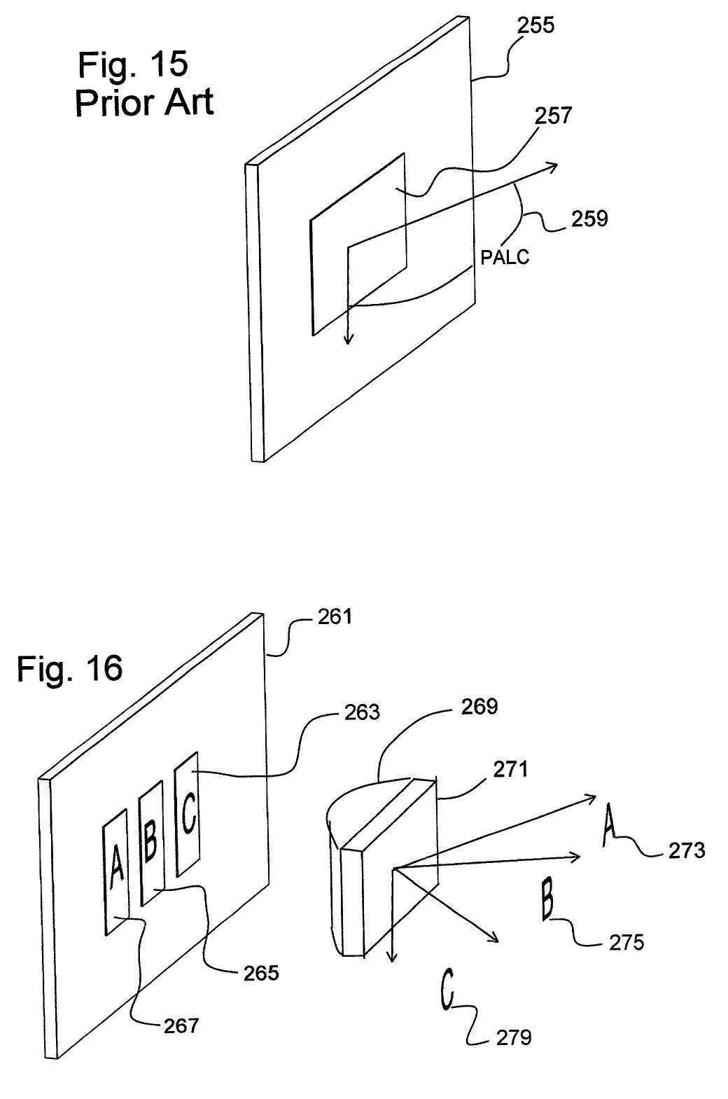

FIG. 15 prior art is a LCD pixel with the PALC (prior art liquid crystal) viewing angle. A prior art LCD display (enlarged) 255 has a series of pixel elements similar to prior art LCD pixel element 257. Each such pixel having a LCD prior art viewing angle 259.

FIG. 16 is a segmented pixel LCD with multiple viewing angles A, B, and C of the present invention. Three pixel segments of the present invention replace the one prior art LCD pixel 257. A LCD pixel 267 carries a first LCD video stream, B LCD pixel 265 carries a second LCD video stream, C LCD pixel 263 carries a third LCD video stream. Each respective LCD stream being split into three respective LCD user spaces include A LCD user space 273, B LCD user space 285, and C LCD user space 279. The 261 being similar in function and structure to the 255 prior art element. The 269 being similar in structure and performance to the 91 element of FIG. 4. The 269 and the 271 being elements representing one segmented pixel component performing similarly and structured similar to element 89 of FIG. 4, incorporating arrays of elements similar to 91 and 93 also of FIG. 4.

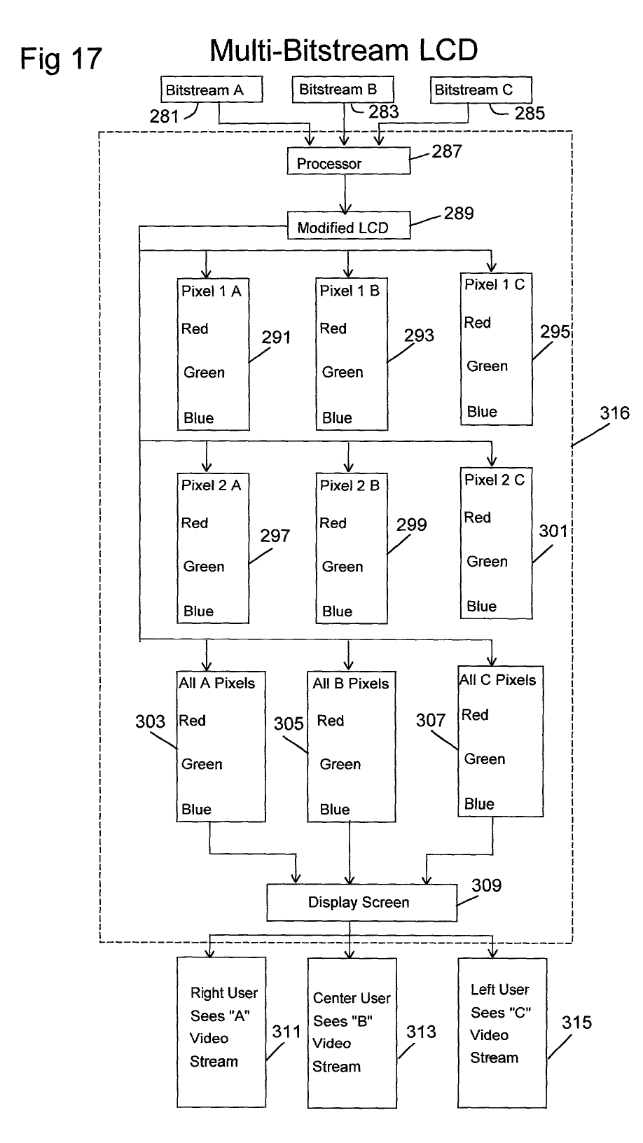

FIG. 17 is a flowchart of the multi-bit stream LCD process of the present invention. A LCD bit stream A 281, a LCD bit stream B 283, and a LCD bit stream C 285 all pass through a LCD processor 287. A LCD display 289, through the application of select voltages, produces a first 1A pixel segment 291 to convey information from the 281 bit stream, a second 1B pixel segment 293 to convey information from the 283, and a third 1C pixel segment 295 to convey information from the 285. The LCD uses electric current to so activate all of the pixel segments on the entire monitor according to the process of displaying a pixel segments with the 281 information, pixel segments with the 283 information, and pixel segments with the 285 information. Visible light from said pixel segments being displayed on a LCD display screen 309 which has an element similar to 89 of FIG. 4. Whereupon a right hand LCD user sees bit stream A 331, a center LCD user sees bit stream B 313, and a left hand LCD user sees bit stream C 315.

Operation of the Invention

First Embodiment

FIG. 1 illustrates select modified CRT elements of a segmented three stream pixel of the present invention. A shadow mask 31 has a series of holes similar to a hole 33. On one side of the 31 is a layer of phosphors such as an A phosphor set 35, a B phosphor set 37, and a C phosphor set 39. These phosphors are deposited onto the surface of a CRT tube (not shown) by processes well known in the prior art they need not be separated as illustrated. Beyond the phosphors (and the CRT glass not shown) is CRT segmented pixel lens 41 which has a columnar lens on a first surface and a planar lens on a second surface referred to as a planar CRT surface 43). The 43 is the exposed monitor surface which the user sees. The 41 and 43 reside in a structure similar to 89 of FIG. 4.

FIG. 2 prior art, illustrates the viewing angle of a PACRT (prior art CRT) single stream pixel. A prior art electron stream 45 is fired through a prior art shadow mask 47 to strike a prior art phosphor pixel 49 which is deposited on a prior art CRT glass 51. Said phosphor pixel then illuminates the user space such that a user within a PACRT user space can see the pixel.

FIG. 3a is the RV (right view) user space angle of a modified segmented CRT pixel of the present invention. An electron stream 55 passes through a segmented shadow mask 57 striking a first phosphor section 59 which emits a segmented visible light 61 and 63 said light then passing through a CRT pixel segmenting lens 64 to produce a first viewing angle range 65 in a user space. A user A 67 being within said first viewing angle. The 64 resides in a structure similar to 89 of FIG. 4.

FIG. 3b is the CV (center view) user space angle of a modified segmented CRT pixel of the present invention. 3b is the same pixel as 3a with the electron stream having advanced to the next segment of the pixel. A center CRT pixel segment 69 emits visible light which is viewable in a center CRT viewing angle 71. User B 73 being within said viewing angle.

FIG. 3c is the LV (left view) user space angle of a modified segmented CRT pixel of the present invention. 3c is the same pixel as 3a with the electron stream having advanced two pixel segments. A right CRT pixel segment 75 emits visible light which is viewable in a left CRT viewing angle 77. User C 79 being within said viewing angle.

FIG. 4 illustrates the modified CRT elements of the present invention. A CRT 81 has within it the element to fire electrons 83 through a modified shadow mask 85 such that they strike the present invention phosphors 87. 87 then emitting angularly directed light 95. Said light being so directed by a pixel lens array containing elements similar to arrayed pixel lens 91. Said pixel lenses are separated from on another using light absorbing barriers similar to barrier 93 which are integrated into a CRT lens array assembly 89 consisting of the lens array and barriers that are used to segment the phosphor light into distinct viewing angles using the 91 and similar structures for each segmented pixel elements while preventing cross contamination using the 93 and similar structures for each segmented pixel element. The 91 operating as a lens and the 93 operating as a light absorbing barrier.

FIG. 5a illustrates the RV (right view) user space of a modified CRT monitor of the present invention. A functioning CRT 96a includes the elements described in FIG. 4 and of FIG. 3a. When all of the left hand pixel elements (similar to 59) are excited by electrons, they emit a video stream which is fully viewable only in the RV viewer space 97. A viewer A 99 seeing the video stream on the entire front (right side) surface of the 96a.

FIG. 5b illustrates the CV (center view) user space of a modified CRT monitor of the present invention. A functioning CRT 96b is the same CRT as 96a, it includes the elements described in FIG. 4 and of FIG. 3a. When all of the center pixel elements (similar to 69) are excited by electrons, they emit a video stream which is fully viewable only in the CV viewer space 101. A viewer B 103 seeing the video stream on the entire front surface of the 96b.

FIG. 5c illustrates the LV (left view) user space of a modified CRT monitor of the present invention. A functioning CRT 96c is the same CRT as 96a, it includes the elements described in FIG. 4 and of FIG. 3a. When all of the right hand pixel elements (similar to 75) are excited by electrons, they emit a video stream which is fully viewable only in the LV viewer space 105. A viewer C 107 seeing the video stream on the entire front surface of the 96c.

FIG. 6 illustrates the concurrent RV, CV, and LV in the user space of a CRT monitor of the present invention. It includes the same CRT 96d as was in FIGS. 5a, 5b, and 5c except the three video streams and users are displayed concurrently. A first user space 109, a second user space 111, and a third user space 113 each respective receive completely different video streams concurrently.

FIG. 7 is a flowchart of some element of the multi-Bit stream CRT of the present invention. A CRT bit stream A 115, a CRT bit stream B 117, and a CRT bit stream C 119 all pass through a CRT processor 121. A CRT electron gun 123 excites phosphors in series such that a first 1A pixel segment 125 is excited to convey information from the 115 bit stream, then a second 1B pixel segment is excited to convey information from the 117, and a third 1C pixel segment is excited to convey information from the 119. The electron gun the proceeds to excite all of the pixel segments on the entire monitor according to the process of exciting a segment with the 115 information, then a segment with the 117 information, then a segment 119 information. Visible light from said excited pixels being displayed on a CRT display screen 143. Whereupon a right hand CRT user sees bit stream A 145, a center CRT user sees bit stream B 147, and a left hand CRT user sees bit stream C 149.

Second Embodiment

FIG. 8 prior art shows elements of prior art projection TV elements including the PAP (prior art projection) viewing angle. A prior art light 151 passes through a first prior art optic 153, through a prior art color filter 155, a second period art optic 157, reflecting off a prior art DMD 161, through a prior art lens 167, to emerge as a series of prior art color pixels 169. Each pixel such as prior art projection pixel 175 being observable on a prior art projection screen 171 across an angle in prior art user space 173.

FIG. 9 is an enlarged view of one pixel of FIG. 8 with the PAP viewing angle. An enlarged prior art projection screen 171a having one such enlarged prior art projection pixel 175a which is viewable across a prior art projection pixel viewing angle 173a.

FIG. 10 illustrates the three modified segmented viewing angles of the present invention in the projection TV embodiment. A light 177 passes through a first optic 179, through a color filter 181, a second optic 183, off a modified DMD 187, through a lens 193, to emerge as a series of color pixels 195. Each pixel being segmented and the visible light of which is directed into three distinct streams from a modified projection screen 197. A projection stream 199 being observable within a first projection user space, B stream 201 being observable in a second projection user space, and C stream 203 being observable in a third projection user space. Said segments being so directed according to the art of FIG. 11 into three sections. Said modified DMD being modified according to the art of FIG. 13. A DMD processor 189, and a memory 185 being integrated into a modified DMD chip 185.

FIG. 11 is one enlarged segmented three stream pixel of FIG. 10. It is an enlarge view of one projection screen 207 pixel segmented into three information streams. A projection stream 213 is displayed on the screen, as is B projection stream 211, and C projection stream 209. Light of each respective stream is directed by a cylindrical planar projection lens with a cylindrical side 205 and a planar side 197a. Such that the video information is segmented into three distinct user spaces. Projection user space A 199a receiving the A stream, projection user space B 201a receiving the B stream, and projection user space C 203a receiving the C projection stream. The 197a being a blown up small section of the 197 surface. The 207 being similar in function and structure to 171a prior art element. The 205 being similar in structure and performance to the 91 element of FIG. 4. The 205 and the 197a being elements representing one segmented pixel component performing similarly and structured similar to element 89 of FIG. 4, incorporating elements similar to 91 and 93 also of FIG. 4.

FIG. 12 prior art illustrates four mirror elements of a DMD. Each prior art mirror segment similar to prior art segment 215 is designed to carry information from one pixel into the projected user space. FIG. 12 is an enlarged view of a small section of 161 of FIG. 8.

FIG. 13 shows the segmented DMD video elements of the present invention. FIG. 13 illustrates that the 215 section of FIG. 12 is replaced by a first mirror segment 217, second mirror segment 218, and third mirror element 219. The 217 carries the A projection stream, the 218 carries the B projection stream and the 219 carries the C projection stream of FIG. 11. FIG. 13 is an enlarged view of a small section of 187 of FIG. 10.

FIG. 14 is a flow chart of the multi bit stream DMD process of the present invention in the projection TV embodiment. A DMD bit stream A 221, a DMD bit stream B 223, and a DMD bit stream C 225 all pass through a DMD processor 227. A modified DMD 229 reflects light such that A first 1A pixel segment 231 is reflected to convey information from the 221 bit stream a second 1B pixel segment is reflected to convey information from the 223, and a third 1C pixel segment is reflected to convey information from the 225. The modified DMD also reflects all of the pixel segments on the three entire video streams according to the process of reflecting a segment with the 221 information, a segment with the 223 information, and a segment 225 information. Visible light from said reflected pixels being displayed on a DMD display screen 248 which has an element similar to 89 of FIG. 4. Whereupon a right hand DMD user sees bit stream A 249, a center DMD user sees bit stream B 251, and a left hand DMD user sees bit stream C 253.

Third Embodiment

FIG. 15 prior art is a LCD pixel with the PALC (prior art liquid crystal) viewing angle. A prior art LCD display (enlarged) 255 has a series of pixel elements similar to prior art LCD pixel element 257. Each such pixel having a LCD prior art viewing angle 259.

FIG. 16 is a segmented pixel LCD with multiple viewing angles A, B, and C of the present invention. Three pixel segments of the present invention replace the one prior art LCD pixel 257. A LCD pixel 267 carries a first LCD video stream, B LCD pixel 265 carries a second LCD video stream, C LCD pixel 263 carries a third LCD video stream. Each respective LCD stream being split into three respective LCD user spaces include A LCD user space 273, B LCD user space 285, and C LCD user space 279. The 261 being similar in function and structure to the 255 prior art element. The 269 being similar in structure and performance to the 91 element of FIG. 4. The 269 and the 271 being elements representing one segmented pixel component performing similarly and structured similar to element 89 of FIG. 4, incorporating arrays of elements similar to 91 and 93 also of FIG. 4. FIG. 17 is a flowchart of the multi-bit stream LCD process of the present invention. A LCD bit stream A 281, a LCD bit stream B 283, and a LCD bit stream C 285 all pass through a LCD processor 287. A LCD display 289, through the application of select voltages, produces a first 1A pixel segment 291 to convey information from the 281 bit stream, a second 1B pixel segment 293 to convey information from the 283, and a third 1C pixel segment 295 to convey information from the 285. The LCD uses electric current to so activate all of the pixel segments on the entire monitor according to the process of displaying a pixel segments with the 281 information, pixel segments with the 283 information, and pixel segments with the 285 information. Visible light from said pixel segments being displayed on a LCD display screen 309 which has an element similar to 89 of FIG. 4. Whereupon a right hand LCD user sees bit stream A 331, a center LCD user sees bit stream B 313, and a left hand LCD user sees bit stream C 315.

Conclusion, Ramifications, and Scope

Thus the reader will see that the Multiple Bit stream Directional Video Monitor Apparatus and Process of this invention provides a novel unanticipated, highly functional and reliable means for distributing multiple video streams to segmented user spaces such that users within each respective space can video distinct video streams.

While my above description describes many specifications, these should not be construed as limitations on the scope of the invention, but rather as an exemplification of a preferred embodiment thereof. Many other variations are possible. Many types of video monitors are well known. For example, many techniques for projecting images are well known and could be used by one skilled in the art to physically segment multiple video streams according to the present invention. Many optical elements and combinations thereof are possible. It should be understood that the term “video monitor” refers to a television screen, a computer screen, a video game screen, or device which substantially provides images to a user.

I claim:

1. A video display configured to segment multiple video streams into a multiple user space such that each individual video stream segment is visible only within a respective section of said user space.

2. The invention of claim 1 wherein said multiple video streams are emitted from a cathode ray tube.

3. The invention of claim 1 wherein said multiple video streams pass through a transmissive projection element.

4. The invention of claim 1 wherein said multiple video streams are reflected from a reflective projection element.

5. A method of utilizing one video display unit to provide multiple video streams concurrently comprising:
a light source to send light representing a first stream of video information and a second stream of video information,
a means for splitting said light representing said first stream of video information and directing it into a first user space, and
a means for splitting said light representing said second stream of video information and directing it into a second user space, wherein
a first user located in said first user space can view said first stream of video but not said second stream of video, and
a second user located in said second user space can view said second stream of video but not said first stream of video.

6. The invention of claim 5 wherein said light source is a cathode ray tube.

7. The invention of claim 5 wherein light from said light source passes through a transmissive projection element.

8. The invention of claim 5 wherein light from said light source is reflected from a reflective projection element.
